(19) United States
(12) Patent Application Publication
(10) Pub. No.: US 2014/0259693 A1
(43) Pub. Date: Sep. 18, 2014

(54) Safety Cutter

(71) Applicant: PACIFIC HANDY CUTTER, INC., (US)

(72) Inventors: Markus Gropl, Huntington Beach, CA (US); Brandon L. Spoelstra, Costa Mesa, CA (US); Joseph P. Garavaglia, Newport Beach, CA (US); Mark Marinovich, Rancho Santa Fe, CA (US)

(21) Appl. No.: 13/844,833

(22) Filed: Mar. 16, 2013

(51) Int. Cl. B26B 25/00

(52) U.S. Cl. CPC B26B 25/005
USPC 30/278

(57) ABSTRACT

A safety cutter includes a handle and a recessed blade that is rotatably coupled to a head portion of the cutter. The blade is recessed relative to the opening of a channel or slot that receives the edge of a work piece or object to be cut. When brought into cutting engagement with an object to be cut, the blade rotates continually revealing (as it turns) a different cutting edge portion.

### CROSS-REFERENCE TO RELATED APPLICATIONS

This application is related to U.S. Design patent application No. ______, entitled “Safety Cutter” filed herewith, which is hereby incorporated by reference.

### TECHNICAL FIELD

The present invention relates generally to cutters and, in particular, a hand tool such as a safety cutter with a recessed rotatable cutting edge.

### BACKGROUND ART

A great variety of knives, cutters, safety cutters, and cutter apparatuses are known. Features variously found in prior knives, cutters, safety cutters, and cutter apparatuses include mechanisms and devices facilitating, for example, blade deployment, blade locking, blade depth adjustment, blade change, or blade storage. Various ergonomic devices and apparatuses are also known.

Unfortunately, known hand-held cutters, utility knives and the like are often cumbersome, inconvenient, difficult or tedious to operate, or lacking in features that might improve worker efficiency, increase the useable life of the cutter, and/or decrease the likelihood of injuries resulting from contact with blades. Cutters with replaceable blades often present to an operator or user potential hazards associated with blade replacement. Cutters with blades that are not accessible by a user (for example, and in the case with some “disposable” knives) can likewise be cumbersome or inconvenient, poorly suited for use in relation to particular tasks or styles of work, or suffer from various other safety and/or operational deficiencies. Additionally, the cutting edge of a blade, replaceable or otherwise, is subject to wear that may vary in degree for different portions of a cutting edge and depending upon cutting actions, user skill and technique, and objects being cut.

It would be useful to be able to provide a safety cutter with a mechanism or device that extends blade life. It would be useful to be able to provide a safety cutter with a mechanism or device that improves cutting safety.

### SUMMARY OF THE INVENTION

In an example embodiment, a safety cutter includes a handle and a recessed blade that is rotatably coupled to a head portion of the cutter.

In an example embodiment, a safety cutter includes a handle having a head portion with an opening configured for receiving the edge of a work piece to be cut, and a circular blade rotatably coupled to the head portion such that edge portions of the blade are recessed in relation to the opening.

In an example embodiment, a safety cutter includes a handle having an opening and a blade coupled to the handle such that edge portions of the blade are advanced rotating through the opening when the blade is pulled into frictional engagement with an object being cut.

### BRIEF DESCRIPTION OF THE DRAWINGS

FIG. 1 is a perspective view of an example embodiment of a safety cutter;

FIG. 2 is an exploded perspective view of the safety cutter of FIG. 1;

FIG. 3 is a left side view of the safety cutter;

FIG. 4 is a cross-sectional view along lines 3-3 of FIG. 3 through the pivot axis of the cutter head and circular rotatable blade therein;

FIG. 5 shows the safety cutter in use pulled by a user in relation to a work piece in a direction indicated (by the arrow); and

FIG. 6 shows the cutter head in cross-section with arrows additionally indicating a direction of rotation of the circular blade in response to the safety cutter being used as shown in FIG. 5.

### DISCLOSURE OF INVENTION

Devices and methods described herein involve a safety cutter with a recessed blade that is rotatably coupled to a head portion of the cutter. In example embodiments, the blade is recessed relative to the opening of a channel or slot that receives the edge of a work piece or object to be cut. When brought into cutting engagement with an object to be cut, the blade rotates continually revealing (as it turns) a different cutting edge portion. This advantageously provides a greater amount of available cutting edge compared to the fixed blade of a conventional recessed-blade disposable safety cutter, the usable part (of said conventional cutter) being the relatively short length of cutting edge spanning across its channel or slot.

Referring to FIGS. 1-4, in this example embodiment, a safety cutter 100 includes a handle having a head portion (e.g., as shown). Left and right side handle portions 102 and 104 are fastened together securing a circular blade 106 to the handle. The head portion include a channel (or slot) 108 configured for receiving the edge of a work piece to be cut. The circular blade 106 is rotatably coupled to and located within the head portion such that its circular blade edge is recessed in relation to the opening of the channel 108. The blade 106 is supported by a pivot axis 110 of the handle. In example embodiments, the handle is ergonomic in shape (e.g., for easy gripping).

In this example embodiment, the head portion is configured with recesses/openings 112 including a side opening through which the circular blade is visible, and recesses at either side of the head portion distal to the cutting location (at blade edge) in the channel 108. In this example embodiment, a base portion of the cutter includes a tape splitter 114. In example embodiments, the safety cutter 100 includes complementary or interfitting portions 116 (e.g., as shown) and the left and right side handle portions 102 and 104 are joined together by a sonic weld.

With regard to materials, the left and right side handle portions 102 and 104 can be formed of various materials, for example, 20% glass filled nylon, and by various processes (e.g., injection molding). The circular blade 106 can be formed of various materials, for example, stainless steel.

Thus, in an example embodiment, a safety cutter includes a handle and a recessed blade that is rotatably coupled to a head portion of the cutter.

Thus, in an example embodiment, a safety cutter includes a handle having a head portion with an opening configured for receiving the edge of a work piece to be cut, and a circular blade rotatably coupled to the head portion such that edge portions of the blade are recessed in relation to the opening.

Thus, in an example embodiment, a safety cutter includes a handle having an opening and a blade coupled to the handle such that edge portions of the blade are advanced rotating through the opening when the blade is pulled into frictional engagement with an object being cut.

Although the present invention(s) has(have) been described in terms of the example embodiments above, numerous modifications and/or additions to the above-described embodiments would be readily apparent to one skilled in the art. It is intended that the scope of the present invention(s) extend to all such modifications and/or additions.

What is claimed is:

1. A safety cutter comprises:
a handle; and
a recessed blade that is rotatably coupled to a head portion of the cutter.

2. The safety cutter of claim 1, wherein the head portion includes a side opening through which the recessed blade is visible.

3. A safety cutter comprises:
a handle having a head portion with an opening configured for receiving the edge of a work piece to be cut; and
a circular blade rotatably coupled to the head portion such that edge portions of the blade are recessed in relation to the opening.

4. The safety cutter of claim 3, wherein the handle is formed of two portions one of which includes a pivot axis about which a central opening of the circular blade is positioned.

5. A safety cutter comprises:
a handle having an opening; and
a blade coupled to the handle such that edge portions of the blade are advanced rotating through the opening when the blade is pulled into frictional engagement with an object being cut.

6. The safety cutter of claim 5, wherein the handle is formed of two portions sonically welded together to prevent removal of the blade from the handle.

7. The safety cutter of claim 5, wherein the handle includes left and right sides configured with interfitting portions.
